(19) United States
(12) Patent Application Publication
(10) Pub. No.: US 2015/0250133 A1
(43) Pub. Date: Sep. 10, 2015

(54) ANIMAL LITTER AND PROCESS OF MAKING

(71) Applicant: THE ANDERSONS, INC., Maumee, OH (US)

(72) Inventors: Joseph Schumski, Maumee, OH (US); Beth Hornyak, Maumee, OH (US)

(21) Appl. No.: 14/643,506

(22) Filed: Mar. 10, 2015

Related U.S. Application Data
(60) Provisional application No. 61/950,499, filed on Mar. 10, 2014.

(51) Int. Cl. A01K 1/015

(52) U.S. Cl. CPC A01K 1/0155

(57) ABSTRACT

A biodegradable, clumpable cat litter made from corncob and biomass components. The animal litter is a mixture of low swellability particles and pellets or fragments thereof of high swellability material. The low swellability particles are formed of corncob grit. The particles and pellets, if present are coated with mineral oil to which is adhered to a clumping agent. The low swellability particles compose 70%-1000% and the remainder is a mixture is composed of the high swellability pellets or fragments thereof.

### RELATED APPLICATIONS

This application claims priority benefit of U.S. Provisional Application Ser. No. 61/950,499 filed Mar. 10, 2014; the contents of which are hereby incorporated by reference.

### FIELD OF THE INVENTION

The present invention relates in general to a disposable animal litter and a method of making the same, and in particular to an animal litter formed primarily of cellulosic grit substantially free of corncob chaff and pith with a finely ground clumping agent.

### BACKGROUND OF THE INVENTION

Corncob grit has been used as animal litter for some time. As shown in FIG. 1 a corn cob 2 is composed of grit that is the hard woody ring portion 4 of the corn cob 2, with the remainder of the cob 2 being pith 6 and chaff 8. Corncob grit 4 is used as litter because it is compostable, biodegradable, and has superior odor control properties. However, only 60% of the cob 2 is grit 4 is high value, so the remaining 40% of the cob is a comparative low value product relative to the grit. Traditionally, this remaining 40% of the cob in the form of chaff 8 and pith 6 has been used to form light density pelletized particles in animal litter. However, demand for corn chaff and pith by the oil industry for use in drilling and by the natural gas industry for use in the fracking process for sourcing natural gas has caused an escalation in the demand and value of the corn cob byproducts. The absorption rate of grit is not fast enough to absorb all of the urine before it reaches the bottom of the tray. Chaff and pith mixture because of the rapid mixture absorption has traditionally been used to speed urine absorption.

The aforementioned demand for cob products in the energy industry has resulted in an imbalance in the cob fractions as it relates to production vs. market opportunities. Specifically this has meant that more opportunities exist for the pith fractions of the cob then are currently present for the grit fractions of the cob. This is due almost entirely to the increase in demand for pith in the absorbents market, most specifically in hydraulic fracturing.

“XRP” is used herein synonymously with the pith fraction of cob.

This shift in demand requires an outlet for the grit portion so as to keep inventories in check. One of the most profitable demand outlets for grit is the cat litter market. The current cob blend of cat litter has roughly 60% grit and 40% XRP, where this blend is very similar to the yields of milling a corn cob so as all portions of the cob are used. By greatly reducing or eliminating the XRP from the blend, the XRP is made available for use in other more profitable areas, while also decreasing the cost of the cat litter as the grit requires less processing and is thus less costly and better balancing the milling so as to reduce the excess grit inventory.

Clumping agents are used for adhering particulate matter in response to absorbing moisture or liquid. A common example of the use of clumping agents is that of animal litter, were in response to contact with animal urine or secretions the litter absorbs the liquid and the clumping agent forms a grouping or clump of litter material for removal and disposal.

In a study conducted by C. C. Burn and G. J. Mason entitled “Absorbencies of six different rodent beddings: commercially advertised absorbencies are potentially misleading” and published in Laboratory Animals (2005) 39, 68-74, absorbency per unit volume correlated positively with bedding density, while absorbency per unit mass correlated negatively. Therefore, the relative absorbencies of the beddings were almost completely reversed depending on how absorbency was calculated. It is noted that absorbency by volume would be a more relevant measure as beddings tend to be placed in rodent cages to fill a certain volume or depth, not to reach a given mass.

It was further found that corncob was the most absorbent bedding from amongst the six bedding materials tested, and contributed to a low level of ammonia production. The suppression of ammonia production is important since if ammonia levels are allowed to rise in animal cages, the ammonia can cause respiratory damage, eye problems, and skin burns. Concentrations of ammonia in a range of 100 and 300 ppm have also caused lethargy in mice and rats. Ammonia can build up if cages are not cleaned frequently enough, if there is a high density of animals, if ventilation rates are low, or if ambient temperature and/or humidity are favorable for bacterial growth.

Furthermore, in a study conducted by Scott E. Perkins and Neil Lipman entitled “Characterization and Quantification of Microenvironmental Contaminants in Isolator Cages with a Variety of Contact Beddings” and published in Contemp. Top Lab Anim. Sci 1995 May; 34/(3) 93-8, that corncob bedding Bed O' Cobs™, combination size, The Anderson Lab Division, Maumee, Ohio exhibited no accumulation of ammonia over a seven day period in test cages.

Under a microscope, cob resembles a sponge. The sponge-like characteristics of cob allow the cob to absorb 2-6 times its weight in aqueous liquids. The cob cells trap and hold moisture, controlling ammonia levels. The resulting dry bedding does not allow bacteria growth, eliminating the presence of ammonia and associated odors, and providing a much healthier environment.

Clumpable animal litter formed of particles of bentonite clay, as disclosed in U.S. Pat. No. 5,000,115 has also been used for some time. The particles of the bentonite clay adhere together and form a clump when moistened by animal dross. The clump of the moistened litter may then be easily removed from the litter box with a scoop and discarded, thereby extending the useful life of a batch of litter. However, bentonite clay used in clumpable cat litter contains mica. Health concerns have been raised about mica for both the animal and personnel contacting the litter and dust therefrom. Among the common alternative components found in clumping agents are various types of starches, gums, and cellulose.

Known animal litters are easily “tracked” by the animals. Tracking occurs when litter adheres to the paws or feet of the animal and is carried outside the litter box when the animal leaves. The litter then gradually leaves the paws or feet of the animal, leaving a “track” of litter particles. Accordingly, it would be advantageous to produce a clumpable, biodegradable animal litter which was safe to use, easily disposed of, and has minimal tracking.

Thus, there exists a need for a substitute for corn cob chaff and pith in light density pelletized particles. There also exists a need for a litter having reduced levels or no loadings of guar gum and XRP.

### SUMMARY OF THE INVENTION

An animal litter that includes a plurality of biomass low swellability particles, and a plurality of biomass high swellability pellets or fragments of the pellets to form a mixture, where the high swellability pellets or fragments of the pellets being at least one of peanut shells, beeswing, grasses, straw, soy hulls, sunflower hulls, oat hulls, rice hulls, corn stalks, pecan shells, corn husks, spelt hulls, or kenaf. In a specific embodiment of the animal litter at least 60% by particle weight of the low swellability particles are sized between 14 mesh and 30 mesh, and the high swellability pellets or fragments of the pellets are sized between 14 mesh and 40 mesh. In a specific embodiment of the animal litter, the low swellability particles have a density generally in the range of 28 to 35 lb/cubic foot, and the high swellability pellets or fragments of the pellets have a density generally in the range of 16 to 27 lb/cubic feet. In a specific embodiment of the animal litter, the low swellability particles are from 70 to 100% of the mixture by weight. In a specific embodiment of the animal litter a dust control agent coating is applied on at least one of the plurality of low swellability particles or the high swellability pellets or fragments of the pellets. In a specific embodiment of the animal litter, a clumping agent is adhered to at least one of the plurality of low swellability particles or the high swellability pellets or fragments of the pellets, where at least 90% by weight of the clumping agent have a screen size less than 20 mesh.

An animal litter that includes a plurality of biomass low swellability particles, where a plurality of biomass high swellability pellets or fragments of the pellets form a mixture, the high swellability pellets or fragments of the pellets being at least one of peanut shells, beeswing, grasses, straw, soy hulls, sunflower hulls, oat hulls, rice hulls, corn stalks, pecan shells, corn husks, spelt hulls, or kenaf, and a coating of an oil and a clumping agent on at least one of the plurality of heavy density particles or the plurality of light density particles. In a specific embodiment of the animal litter, at least 60% of the plurality biomass low swellability particles have a size between 14 mesh and 30 mesh. In a specific embodiment of the animal litter, the clumping agent is present in the range of from 2 to 8 total weight percent, and the oil coating is present in the range of from 0 to 8 total weight percent.

An animal litter made up by a majority of low swellability granules which is lesser absorptive than the high swellability granules and improves the efficacy of the clumping agent by reducing the dehydration rate of the clumping agents. Clumping agents which can maintain their peak hydration over sustained periods improves the clump strength and clump integrity over an extended time between clump removals from the litter box.

### BRIEF DESCRIPTION OF THE DRAWINGS

The present invention is further detailed with respect to the following drawings that are intended to show certain aspects of the present invention, but should not be construed as a limit on the practice of the present invention.

FIG. 1 is a partial cutaway perspective view of a corn cob.

FIG. 2 is a perspective view of a litter box with the inventive animal liter;

FIG. 3 illustrate partial cross-sectional views of both the low swellability particles and high swellability pellets or fragments thereof which are provided with a coating of oil in accordance with an embodiment of the invention; and

FIG. 4 is a block diagram illustrating a method of preparation of the animal liter in accordance with an embodiment of the invention.

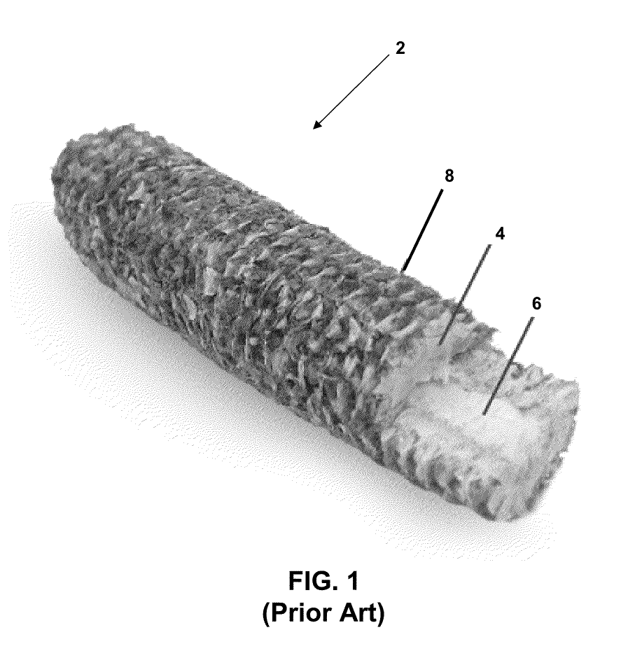

### DESCRIPTION OF THE INVENTION

An animal litter formed of a mixture of low swellability particles and high swellability particles has been developed with a non-guar gum based clumping agent. Both the low and high swellability particles are formed of natural product materials which are biodegradable and compostable. In an inventive embodiment, the low swellability particles are formed of cellulosic grit and the high swellability pellets are formed of pelletized natural materials as a substitute for corncob chaff and pith so as to control the overall water absorption of the litter particulate thereby affording control over the water available for wetting the clumping agent, if present. It is appreciated that certain amounts of corncob chaff and pith remain in an inventive litter, the amount of corncob chaff and pith being limited to less than 30 particle weight percent.

An inventive litter is composed of the low swellability particles which are defined herein as having a volume increase upon immersion in water for 24 hours of up to 80% percent relative the dry volume of the particles. The remainder of the litter is high swellability pellets which are defined herein as particles that have been compressed into pellets, the pellets having a volume increase upon immersion in water for 24 hours of between 150 and 1000% percent relative the dry volume of the pellets. The term “high swellability” with respect to pellets is intended to also encompass fragments thereof. In certain inventive embodiments, the low swellability particles are present from 30 to 70 particle weight percent. Both the low swellability particles and the high swellability pellets are reduced to a predetermined size distribution by techniques illustratively including roller milling and hammer milling techniques.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

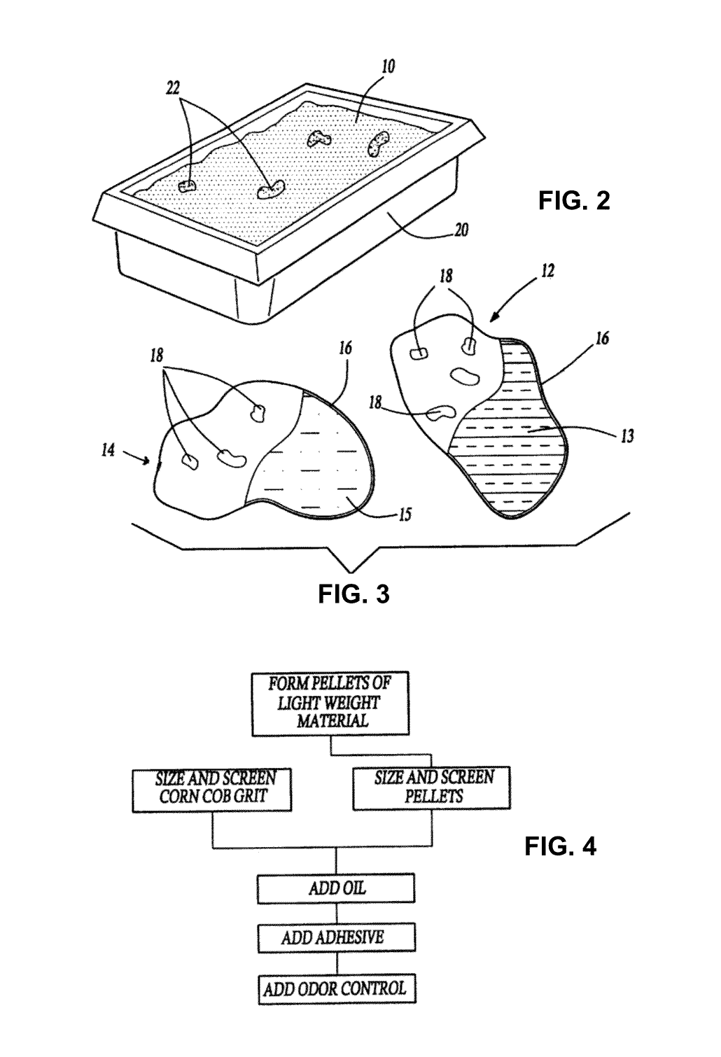

The method includes reducing to size and screening the low swellability material, forming the pellets of high swellability having a predetermined density, reducing to size and screening the sized pellets and forming a homogenous mixture. Additionally, in some embodiments, anti-dusting agents and clumping agents as exemplified by mineral oil; and guar gum or substitutes therefore, are added to coat the particles of low swellability particles and pellets of high swellability material to reduce dust and improve the integrity of the clump; respectively. The animal litter according to the invention has excellent odor control, light weight for given volume, better sorption properties than clay materials. The material is essentially dust free with resort to a surface anti-dusting agent, totally free of carcinogens, and has an aesthetically appealing pale beige color. As shown in FIG. 2, clumpable animal litter 10 in accordance with the invention is shown in a litter box 20. The animal litter is a mixture of low swellability particles 12 and high swellability pellets 14. Both types of the low swellability particles 12 and the high swellability pellets 14 are formed of organic materials. In an inventive embodiment, the low swellability particles 12 are formed of corncob grit 13, i.e., the hard woody ring portion of a corncob, and the high swellability pellets 14 are formed of sized pellets 15 of beeswing wheat bran, beeswing wheat bran, grasses, straw, soy hulls, sunflower hulls, oat hulls, rice hulls, corn stalks, pecan shells, corn husks, corn cob chaff and pith, spelt hulls, kenaf, or combinations thereof or combinations thereof.

The low swellability particles 12 are formed by reducing corncob grit to size by using conventional hammer milling or roller milling techniques. The low swellability particles have a density of about 30±5 lb/cubic foot The grit particles are screened to be generally 8-40 mesh with at least 60% by particle weight of the heavy particles sized between 14 and 30 mesh and in some embodiments up to 95% of the particles sized 14-30 mesh (U.S. Standard). A distribution range is set forth below totaling 100% of grit particles.

TABLE 1
GRIT PARTICLE OR LOW SWELLABILTY PARTICLES

| | | | | |
|---|---|---|---|---|
| Screen Size passed | 8-14 | 14-30 | 30-40 | −40 |
| Typical % by weight of grit | 20-68 | 30-95 | 1-30 | 0-30 |
| (low swellability particles) | | | | |
| Specific exemplary % | 64 | 34 | 1 | 1 |
| by weight | | | | |

The size of the particles affects both the tracking and clumping characteristics of the animal litter. Heavier density particles within the ranges provided are less likely to adhere to the animal and be tracked. Likewise, larger sized particles within the ranges provided are less likely to adhere to the animal and be tracked.

The high swellability pellets 14 are formed from particles compressed in pellets of beeswing wheat bran, grasses, straw, soy hulls, sunflower hulls, oat hulls, rice hulls, corn stalks, pecan shells, corn husks, spelt hulls, kenaf, or combinations thereof. The particles of high swellability material have a density of between 2 and 18 lb/cubic foot before pelletizing and densities as pellets of between 35 and 50 lb/cubic foot. The pellets are reduced to an appropriate size by roller milling and hammer milling. After sizing, the high swellability pellets 14 retain densities of 24 and 30 lb/cubic foot. The high swellability pellets or fragments thereof 14 are screened to be generally 10-60 mesh (USS). In an inventive embodiment, 78% of the particles are 14-40 mesh (U.S. Standard). A typical size distribution for high swellability pellets or fragments thereof 14 is shown in the table 2 below.

TABLE 2
HIGH SWELLABILITY PELLETS OR FRAGMENTS THEREOF

| Screen Size | +10 | 10-14 | 14-20 | 20-40 | 40-60 | 60-80 | -80 |
|---|---|---|---|---|---|---|---|
| % by weight | 0-5 | 10-40 | 30-70 | 30-70 | 0-10 | 0-5 | 0-5 |
| of high | | | | | | | |
| swellability | | | | | | | |
| pellets or | | | | | | | |
| fragments | | | | | | | |
| thereof | | | | | | | |
| Specific | 1 | 26 | 45 | 38 | 3 | 2 | <1 |
| exemplary | | | | | | | |
| % by weight | | | | | | | |

The animal litter is then formed as a mixture of low swellability particles 12 and high swellability pellets of fragments thereof 14. In some inventive embodiments, between 0 and 100 particle weight percent of the mixture is low swellability particles 12 composed of corn cob grit, and the remainder of the mixture is high swellability pellets of fragments thereof 14. Additives operative herein illustratively including anti-dusting agents, clumping agents, clumping accelerants, colorants, or deodorants. Each of these additives is typically present from 0 to 12 total weight percent. With total additives amounting to between 0 and 20 total weight percent with the remainder being particles 12, alone or in combination with pellets 144, respectively.

In the preferred embodiment, the mixture is 70-100% by particle weight low swellability particles 12 and 30-0% by weight high swellability pellets of fragments thereof 14. Thus, in addition to the excellent sorption, odor control, clumping, and tracking properties of the mixture, the mixture is economical because there is little or no waste.

The mixture has a combined density of from 23 to 35 lb/cubic foot, and it has been found that this mixture provides an appropriate balance of densities and sizes to minimize tracking, and maximize animal urine sorption, and clumpability. The particle size distribution set forth above provides excellent clumping and a proper urine sorption rate. If the size of the particles is either too large or too small, the clumping ability is negatively affected. A smaller average size of the high swellability material facilitates clumping with the larger average size low swellability material. The clump 22 of litter disintegrates in the water of a toilet and is easily flushed away. If a clump 22 is not to be flushed, it will remain formed as a clump for other manners of disposal. Without intending to be bound to a particular theory, as high swellability pellets or fragments thereof have a water absorption ability several times greater than that of the to low swellability particles as used herein, the competition between high swellability pellets and clumping agent for water of hydration should be considered to assure that the clumping agent is adequately wetted to achieve clump formation with the strengths so desired herein. Additionally, it is noted that swelling of particles regardless of type typically occurs over a span of 24 hours that has the effect of reduced clump strength at 24 hours relative to 30 minutes after litter wetting by urine. This phenomenon is readily compensated for by increasing 30 minute clump strength values to achieve desired clump strength values at later times, such as 24 hours after wetting of the inventive litter that are desired.

If the urine absorption rate is too low, urine is absorbed too slowly and some of it flows to the bottom of the litter pan 20, where the litter forms clumps which adhere to the pan 20. These clumps are difficult to remove. When both particles 12 and pellets or fragments thereof 14 are sized as set forth above, the high swellability pellets, if present, have a sufficiently high sorption rate to take up the urine in the top layers of the litter. A clump 22 is then formed in the top layer of the litter that is easily scooped out of the litter box 20 for disposal by flushing down the toilet or other suitable manner.

As shown in FIG. 3, both the low swellability particles 12 and high swellability pellets or fragments thereof 14 are provided with a coating 16 of oil. In the preferred embodiment, the coating 16 is mineral oil and is added as 1-8% by weight of the total weight of the mixture of particles 12 and pellets 14. The oil eliminates dust during mixing, handling, packaging, and use. Other oils such as mineral seal oil, vegetable oils, or any of a series of paraffinic or naphthenic distillates may also be used.

Although the mixture of sized pellets of light density material, if present, and sized heavy density material readily forms clumps, these clumps tend to degrade over time. Accordingly, in the inventive embodiments the integrity of the clump is maintained by adding particles of a clumping agent 18, where the clumping agent is guar gum or a substitute for guar gum. In certain inventive embodiments, the clumping agent 18 is added to be in the range of 2 to 6 total weight percent. The particle size distribution and viscosity of the clumping agent 18 is critical to achieve good clumping. In an inventive embodiment, 95% of the clumping agent 18 particles are smaller than 200 mesh (U.S. Standard). The viscosity of the clumping agent 18 should be more than 3500 cps in a 1% aqueous solution after 24 hours.

The clumping agent 18 is formulated in certain inventive embodiments from a combination of a finely ground pre-gelatinized potato based starch and a finely ground cellulose such as carboxymethyl cellulose (CMC) that provides clump durability of at least 95%. The clumping agent 18 eliminates the use of guar gum and other expensive gums while maintaining the required clumping durability.

In still other embodiments, the potato starch as a pre-gelled starch is also milled to at minimum to a −80 sieve size. While untreated starch requires heat to thicken or gelatinize, when a starch is pre-cooked, it can then be used to thicken instantly in cold water. This is referred to herein as a pre-gelatinized starch.

In an embodiment to avoid segregation between the potato starch and CMC upon blending, both clumping agents should have at a minimum 80% by weight passing a 200 mesh screen size, and preferably 95% passing a −200 mesh screen. In certain inventive embodiments, the clump durability as measured by the Goldstein clump strength test method is a minimum of 90%, and in still other embodiments to a clump strength of 95%.

The fine grind materials of the clumping agent are powdered by milling them through a screen or grinding. Milling to a powder to the above size distributions is readily accomplished with a commercially available milling machine, hammer mill, pin mill, knife mill, air mill, cryogenic mill, or pulverizer. A Champion hammer milling machine (Waterloo, Iowa) is representative of such a milling machine.

In some inventive embodiments, the CMC may be substituted with other celluloses such as ethylcellulose, hydroxyethylcellulose, hydroxy-methylethylcellulose, hydroxyethylpropylcellulose, methylhydroxyethyl-cellulose, and methylcellulose, in total or in place of part of the CMC.

In certain inventive embodiments, the performance of the clumping agents is enhanced with clumping accelerants. Clumping accelerants operative herein illustratively include borax, sodium borate, sodium aluminate, and combinations thereof. Optionally, a dust control agent (DCA) may be used to control potential dust from the find grinds of a base material, and to tack the clumping agent on to the surface of the base material.

The use of biobased materials for the clumping agent offers several advantages. Biobased materials are renewable resources and are particularly suited to potentially lowering the carbon footprint, and are suitable for composting, and therefore have the potential to lessen landfill burdens.

Advantageously, an odor control agent, copper sulfate, fungicide, lime, sodium bicarbonate, or materials identified in U.S. Pat. No. 5,195,465, to prolong the life of cellulosic-based litters may be added at 0 to 1% of weight of the mixture. Additionally, an odor control material and fragrance as well as a bactericide such as Myacide S2 produced by Angus Chemical, may be added.

### Method of Preparation

As shown in FIG. 4, after separating the grit from the pith and chaff, the corncob grit is subjected to roller milling and hammer milling and screened to form the proper size distribution as set forth above. The high swellability components are formed in pellets according to a suitable method such as described in U.S. Pat. No. 5,207,389. The pellets are formed to have a density of 16 to 27 lb/cubic foot The pellets are then reduced to the appropriate size by roller milling and hammer milling techniques and screened to obtain the high swellability pellets or fragments thereof 14. A predetermined amount of low swellability particles (grit) 12 and high swellability pellets or fragments thereof 14, if any are present, are placed in a low shear, fluidizing mixer. The mixer imparts limited shear and limited (raising the temperature by less than 30 degrees Celsius) or no heat to the mixture. The mixer is run sufficiently long, such as 15-600 seconds, to provide a homogenous mixture. The oil, if present, is added to fully coat the particles. The oil is added to the mixer in an amount from 0% to 6% total weight percent of the mixture of particles. It has been found that the oil facilitates the adherence of the clumping agent as well as reducing dust. The next step is adding the clumping agent to the mixture and thoroughly blending the mixture. During the mixing process, the clumping agent adheres to the low swellability particles 12, if present, the high swellability pellets or fragments thereof 14. It has been found that the uniform covering of the oil on the mixture facilitates the adherence of the clumping agent to the particles 12, and if present, pellets 14. The odor control material with fragrance is then added at a rate of about 2 to 3 lb/ton of particles and thoroughly blended. Additionally, at this time fungicide, bactericides or other odor control materials may be added. The litter 10 is then thoroughly blended and is ready for packaging in bags, jugs, boxes, etc.

The litter thus produced is biodegradable and compostable and made from a renewable resource which is free of carcinogens. The litter is half density or more than half the density (0.5-0.7) of conventional clay litter which makes handling of the litter easier. The litter has better sorption than clay materials and excellent clumping characteristics, making it easy to remove the urine from the litter pan. The litter is essentially free of dust and has excellent odor control properties. The blend produces a litter with a minimal amount of tracking compared with previous litters.

As noted corn cob (corn grit—hard woody ring) is extremely effective in controlling ammonia levels when used with lab mice, and thus by increasing cob grit percentage in embodiments of the inventive liter improved odor control is provided. Finally, the color of the litter is aesthetically appealing. The color is controlled by the combination of light color of the heavy portion of the cob and the color of the light density components of the litter. Experimentation has shown that that blends featuring reduced levels of XRP in cat litter and other uses still perform within quality standards and end-user expectations. Example 1 is a procedure for testing a reduced XRP based cat litter, the results of which are summarized in table 3 below.

### Example 1

1. Mix batches of cat litter at different increments of reduced XRP.
2. Pour the mixed litter material into a 6 qt. container (flat bottom plastic shoe box) to a depth of at least 3 inches.
3. Level the top surface of the cat litter by gently shaking and/or using a leveling tool. Avoid a slanted surface. Using a round ladle, make six slight indentations on the top of the litter.
4. Load a 60 mL syringe with the salt solution to the 50 mL mark (to deliver two 25 m charges).
5. Hold the syringe steady, about one inch above an indentation. Add 25 mL of a 2.0% salt solution to one location with targeting a 3 sec delivery time. The liquid should not pool on top of the litter.
6. Add the salt solution to 2 more locations making sure clumps are not too close to each other.
7. For each clump, scoop out the clump after 15 minutes using a tongue depressor. Make sure to get under the clump and to not damage adjoining clumps.
8. Tap the scoop to get rid of most of the loose debris. Gently roll clump in hands to get rid of the rest of the loose debris.
9. Holding the clump with the hand, position it so it will drop on its bottom side onto the middle of the screen. The drop is to be a 12 inch drop to the mesh (use a 12 inch mark).
10. Quickly release the clump without spinning it, allowing it to free fall 12 inches to the center of the screen.
11. Record the clump condition: H for hard; S for soft (but intact); CA for cracked apart; and FA for fell apart into multiple pieces.
12. Place the pan, the screen, what is left of the clump, and the debris (in the pan) on the balance.
13. Record the weight (in grams to 0.1 g) as W1 on the Test Results Chart.
14. Remove the screen (with residual clump) from the pan (with debris) and weigh the screen (with residual clump) separately. Record this weight as W2 on the Test Results Chart.
15. Discard residual clump and debris. Clean the screen and the pan with the brush thoroughly.
16. Calculate an average Percent Hardness (% H).
17. Repeat triplicate clump testing for the times of 1 hour, 24, hours, and 48 hours.

TABLE 3

| | Clumpers | | | % Hardness | | | | Dust Control & | | | | | |
|---|---|---|---|---|---|---|---|---|---|---|---|---|---|
| Batch # | Guar | Pot Starch | Additional | 15 min | 1 hr | 24 hrs | 48 hrs | Other | CDP | 15 min | 1 hr | 24 hrs | 48 hrs |
| 102213E | 2% | 2.0% | Initial Stability, | 98.8 | 98.8 | 95.7 | 95.4 | 4% DCA | | 3H | 3H | 3H | 3H |
| | | | No XRP | | | | | | | | | | |
| 102213E | 2% | 2.0% | 1 month Stability, | 99.3 | 98.7 | 97.4 | 97.1 | 4% DCA | | 3S | 3H | 3H | 3H |
| | | | No XRP | | | | | | | | | | |
| 102213E | 2% | 2.0% | 3 month Stability, | 98.1 | 97.8 | 95.5 | 95.8 | 4% DCA | | 3S | 3H | 3H | 3H |
| | | | No XRP | | | | | | | | | | |
| 102213E | 2% | 2.0% | 6 month Stability, | 99.1 | 98.8 | 95.5 | 95.2 | 4% DCA | | 3S | 3H | 3H | 3H |
| | | | No XRP | | | | | | | | | | |
| 102213E | 2% | 2.0% | 12 month Stability, | 97.7 | 97.1 | 92.8 | 92.7 | 4% DCA | | 3S | H-2S | H-2CA | H-2CA |
| | | | No XRP | | | | | | | | | | |
| 102213G | 2% | 2.0% | Initial Stability, | 99.4 | 98.9 | 97.6 | 95.4 | 1.15% C&D Premix, | Y | 3H | 3H | 3H | 3H |
| | | | No XRP | | | | | 4% DCA | | | | | |
| 102213G | 2% | 2.0% | 1 month Stability, | 99.4 | 99.3 | 97.2 | 98.0 | 1.15% C&D Premix, | Y | 3H | 3H | 3H | 3H |
| | | | No XRP | | | | | 4% DCA | | | | | |
| 102213G | 2% | 2.0% | 3 month Stability, | 99.1 | 97.6 | 95.5 | 96.2 | 1.15% C&D Premix, | Y | 3H | 3H | 3H | 3H |
| | | | No XRP | | | | | 4% DCA | | | | | |
| 102213G | 2% | 2.0% | 6 month Stability, | 98.8 | 98.7 | 95.9 | 96.5 | 1.15% C&D Premix, | Y | 3S | 3H | 3H | 3H |
| | | | No XRP | | | | | 4% DCA | | | | | |
| 102213G | 2% | 2.0% | 12 month Stability, | 98.2 | 98.2 | 93.6 | 95.6 | 1.15% C&D Premix, | Y | 3S | S-2H | CA-2H | 3H |
| | | | No XRP | | | | | 4% DCA | | | | | |
| 102213H | 2% | 2.0% | Initial Stability, | 98.6 | 98.2 | 96.9 | 97.1 | 1.15% C&D Premix, | Y | 3H | 3H | 3H | 3H |
| | | | 20% Less XRP | | | | | 4% DCA | | | | | |
| 102213H | 2% | 2.0% | 1 month Stability, | 99.0 | 98.2 | 98.2 | 98.0 | 1.15% C&D Premix, | Y | 3H | 3H | 3H | 3H |
| | | | 20% Less XRP | | | | | 4% DCA | | | | | |
| 102213H | 2% | 2.0% | 3 month Stability, | 99.0 | 98.1 | 96.1 | 96.7 | 1.15% C&D Premix, | Y | 3H | 3M | 3H | 3H |
| | | | 20% Less XRP | | | | | 4% DCA | | | | | |
| 102213H | 2% | 2.0% | 6 month Stability, | 98.7 | 98.0 | 96.7 | 97.2 | 1.15% C&D Premix, | Y | 3H | 3H | 3H | 3H |
| | | | 20% Less XRP | | | | | 4% DCA | | | | | |
| 102213H | 2% | 2.0% | 12 month Stability, | 98.2 | 98.1 | 95.7 | 95.2 | 1.15% C&D Premix, | Y | 3S | 3H | 3H | 3H |
| | | | 20% Less XRP | | | | | 4% DCA | | | | | |
| 102213K | 2% | 2.0% | Initial Stability, | 98.0 | 96.1 | 96.9 | 97.2 | 4% DCA | | 3S | 3M | 3H | 3H |
| | | | 20% Less XRP | | | | | | | | | | |
| 102213K | 2% | 2.0% | 1 month Stability, | 98.5 | 98.9 | 98.4 | 97.3 | 4% DCA | | 3S | 3H | 3H | 3H |
| | | | 20% Less XRP | | | | | | | | | | |
| 102213K | 2% | 2.0% | 3 month Stability, | 98.7 | 97.5 | 96.1 | 96.4 | 4% DCA | | 3S | 3H | 3H | 3H |
| | | | 20% Less XRP | | | | | | | | | | |
| 102213K | 2% | 2.0% | 6 month Stability, | 98.7 | 98.7 | 96.6 | 96.2 | 4% DCA | | S-2H | 3H | 3H | 3H |
| | | | 20% Less XRP | | | | | | | | | | |
| 102213K | 2% | 2.0% | 12 month Stability, | 97.9 | 97.6 | 93.4 | 95.5 | 4% DCA | | 3S | S-2H | 3H | 3H |
| | | | 20% Less XRP | | | | | | | | | | |
| 102213M | 2% | 2.0% | Initial Stability, | 97.9 | 97.3 | 98.1 | 98.3 | 1.15% C&D Premix, | Y | 3H | 3H | 3H | 3H |
| | | | 40% Less XRP | | | | | 4% DCA | | | | | |
| 102213M | 2% | 2.0% | 1 month Stability, | 99.0 | 98.6 | 97.9 | 98.2 | 1.15% C&D Premix, | Y | 3H | 3H | 3H | 3H |
| | | | 40% Less XRP | | | | | 4% DCA | | | | | |
| 102213M | 2% | 2.0% | 3 month Stability, | 99.0 | 97.7 | 96.9 | 96.9 | 1.15% C&D Premix, | Y | 3H | 3H | 3H | 3H |
| | | | 40% Less XRP | | | | | 4% DCA | | | | | |
| 102213M | 2% | 2.0% | 6 month Stability, | 98.6 | 98.8 | 97.2 | 97.2 | 1.15% C&D Premix, | Y | 3H | 3H | 3H | 3H |
| | | | 40% Less XRP | | | | | 4% DCA | | | | | |
| 102213M | 2% | 2.0% | 12 month Stability, | 98.2 | 98.2 | 95.4 | 96.0 | 1.15% C&D Premix, | Y | 3S | 3H | 3H | 3H |
| | | | 40% Less XRP | | | | | 4% DCA | | | | | |
| 102213P | 2% | 2.0% | Initial Stability, | 99.2 | 98.6 | 99.3 | 99.5 | 4% DCA | | 3H | 3H | 3H | 3H |
| | | | 40% Less XRP | | | | | | | | | | |
| 102213P | 2% | 2.0% | 1 month Stability, | 98.8 | 99.0 | 97.2 | 97.7 | 4% DCA | | 3H | 3H | 3H | 3H |
| | | | 40% Less XRP | | | | | | | | | | |
| 102213P | 2% | 2.0% | 3 month Stability, | 98.8 | 97.5 | 95.2 | 96.8 | 4% DCA | | 3H | 3H | 3H | 3H |
| | | | 40% Less XRP | | | | | | | | | | |
| 102213P | 2% | 2.0% | 6 month Stability, | 98.6 | 97.5 | 96.2 | 96.4 | 4% DCA | | 3S | 3H | 3H | 3H |
| | | | 40% Less XRP | | | | | | | | | | |
| 102213P | 2.0% | 2.0% | 12 month Stability, | 98.6 | 98.3 | 95.3 | 97.3 | 4% DCA | | 3S | 3H | CA-2H | 3H |
| | | | 40% Less XRP | | | | | | | | | | |
| 102213Q | 2% | 2.0% | Initial Stability, | 99.2 | 99.0 | 99.8 | 98.6 | 1.15% C&D Premix, | Y | 3H | 3H | 3H | 3H |
| | | | 60% Less XRP | | | | | 4% DCA | | | | | |
| 102213Q | 2% | 2.0% | 1 month Stability, | 99.0 | 98.1 | 98.1 | 98.4 | 1.15% C&D Premix, | Y | 3H | 3H | 3H | 3H |
| | | | 60% Less XRP | | | | | 4% DCA | | | | | |
| 102213Q | 2% | 2.0% | 3 month Stability, | 98.9 | 97.7 | 96.5 | 97.0 | 1.15% C&D Premix, | Y | 3H | 3H | 3H | 3H |
| | | | 60% Less XRP | | | | | 4% DCA | | | | | |
| 102213Q | 2% | 2.0% | 6 month Stability, | 96.6 | 98.5 | 97.9 | 97.5 | 1.15% C&D Premix, | Y | H-2S | 3H | 3H | 3H |
| | | | 60% Less XRP | | | | | 4% DCA | | | | | |
| 102213Q | 2.0% | 2.0% | 12 month Stability, | 97.9 | 98.3 | 96.9 | 97.2 | 1.15% C&D Premix, | Y | 3S | 3H | 3H | 3H |
| | | | 60% Less XRP | | | | | 4% DCA | | | | | |
| 102213R | 2% | 2.0% | Initial Stability, | 99.2 | 99.4 | 100.0 | 100.0 | 4% DCA | | 3H | 3H | 3H | 3H |
| | | | 60% Less XRP | | | | | | | | | | |
| 102213R | 2% | 2.0% | 1 month Stability, | 98.8 | 99.0 | 97.5 | 96.4 | 4% DCA | | 3H | 3H | 3H | 3H |
| | | | 60% Less XRP | | | | | | | | | | |
| 102213R | 2% | 2.0% | 3 month Stability, | 98.7 | 97.2 | 96.7 | 97.1 | 4% DCA | | 3H | 3H | 3H | 3H |
| | | | 60% Less XRP | | | | | | | | | | |
| 102213R | 2% | 2.0% | 6 month Stability, | 99.0 | 98.2 | 97.6 | 97.0 | 4% DCA | | 3H | 3H | 3H | 3H |
| | | | 60% Less XRP | | | | | | | | | | |
| 102213R | 2.0% | 2.0% | 12 month Stability, | 97.8 | 97.6 | 97.1 | 97.2 | 4% DCA | | 3S | 3H | 3H | 3H |
| | | | 60% Less XRP | | | | | | | | | | |

By greatly reducing or eliminating XRP from the blends, there was an improved quality clumping and a consistent level of hardness. Applicants have also found that the lower the amount of XRP, the longer the odor control is effective for. The more uniform color with little or no XRP also allows for an overall improved appearance. With having more XRP available for other profitable products, a decrease in the cost of the cat litter is possible, and a significant balance in the milling process is possible so as to reduce the excess grit inventory during corn cob processing.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

1. An animal litter comprising:
a plurality of biomass low swellability particles; and
a plurality of biomass high swellability pellets or fragments of said pellets to form a mixture, said high swellability pellets or fragments of said pellets being at least one of peanut shells, beeswing, grasses, straw, soy hulls, sunflower hulls, oat hulls, rice hulls, corn stalks, pecan shells, corn husks, spelt hulls, or kenaf.

2. The animal litter of claim 1, wherein at least 60% by particle weight of said low swellability particles are sized between 14 mesh and 30 mesh.

3. The animal litter of claim 1, wherein said low swellability particles have a density generally in the range of 28 to 35 lb/cubic foot.

4. The animal litter of claim 1, wherein said high swellability pellets or fragments of said pellets have a density generally in the range of 16 to 27 lb/cubic foot.

5. The animal litter of claim 1, wherein at least 60% of said high swellability pellets or fragments of said pellets are sized between 14 mesh and 40 mesh.

6. The animal litter of claim 1, wherein said low swellability particles are from 70 to 100% of said mixture by weight.

7. The animal litter of claim 1, further comprising a dust control agent coating on at least one of said plurality of low swellability particles or said high swellability pellets or fragments of said pellets.

8. The animal litter of claim 7, further comprising clumping agent are adhered to at least one of said plurality of low swellability particles or said high swellability pellets or fragments of said pellets.

9. The animal litter of claim 8, wherein at least 90% by weight of said clumping agent have a screen size less than 20 mesh.

10. The animal liter of claim 1 further comprising corn cob grit, wherein said corn cob grit in said animal litter has functionality in odor control and limiting ammonia build up.

11. The animal litter of claim 10 wherein a pith portion of the corn cob grit is reduced or eliminated.

12. An animal litter comprising:
a plurality of biomass low swellability particles;
a plurality of biomass high swellability pellets or fragments of said pellets to form a mixture, said high swellability pellets or fragments of said pellets being at least one of peanut shells, beeswing, grasses, straw, soy hulls, sunflower hulls, oat hulls, rice hulls, corn stalks, pecan shells, corn husks, spelt hulls, or kenaf; and
a coating of an oil and a clumping agent on at least one of said plurality of heavy density particles or said plurality of light density particles.

13. The animal litter of claim 12, wherein at least 60% of said plurality biomass low swellability particles have a size between 14 mesh and 30 mesh.

14. The animal litter of claim 12, wherein said clumping agent is present in the range of from 2 to 8 total weight percent.

15. The animal litter of claim 12, wherein said oil coating is present in the range of from 0 to 8 total weight percent.

16. An animal litter comprising:
a clumping agent with a majority of low swellability granules in relation to a high swellability granules, where the low swellability granules are lesser absorptive than the high swellability granules which improves the efficacy of the clumping agent by reducing a dehydration rate of the clumping agents; and
wherein the clumping agents maintain a peak hydration over sustained periods that acts to improve the clump strength and clump integrity over an extended time between clump removals from the litter box.
